(19) United States
(12) Patent Application Publication
(10) Pub. No.: US 2014/0247498 A1
(43) Pub. Date: Sep. 4, 2014

(54) COMPACT CONCENTRATOR ASSEMBLY

(71) Applicant: Alonso MARQUEZ, Palmerston (AU)

(72) Inventor: Alonso MARQUEZ, Palmerston (AU)

(21) Appl. No.: 14/277,783

(22) Filed: May 15, 2014

Related U.S. Application Data
(63) Continuation-in-part of application No. 13/652,193, filed on Oct. 15, 2012.

(30) Foreign Application Priority Data
Oct. 17, 2011 (AU) 2011904285

(51) Int. Cl. G02B 19/00; H01L 31/042

(52) U.S. Cl. CPC G02B 19/0004; H02S 40/00
USPC 359/618

(57) ABSTRACT

A ray concentrator assembly (also referred to as concentrator assembly) combining a plurality of micro ray concentrators, ray redirectors and wave pipes. Each micro ray concentrator collects rays from a source, concentrates rays and is normally attached to a ray redirector. Each ray redirector redirects rays from a micro ray concentrator and is normally attached to a wave pipe. Each wave pipe redirects and aggregates rays from a ray redirector to a target and is normally attached to the target.

### RELATED U.S. APPLICATIONS

The present application is a continuation-in-part application under 35 U.S.C. §120 of currently pending U.S. Ser. No. 13652193, filed on 15 Oct. 2012, entitled “CONCENTRATOR ARRAY”.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to a compact concentrator assembly capable of concentrating waves of various types towards a central point to be utilised for various functions such as energy generation

2. Description of Related Art Including Information Disclosed under 37 CFR 1.97 and 37 CFR 1.98.

Concentrators are known and have been used for some time. Utilizing solar radiation by using mirrors or lenses to concentrate a large area of sunlight or solar thermal energy onto a target site is well known. Electrical power can then be produced through concentrated energy by driving an engine or turbine connected to electrical power generators.

Typical concentrator assemblies include parabolic troughs, dish stirlings, concentrating linear Fresnel reflectors, Fresnel lenses and solar power towers. All these assemblies typically operate by reflecting or refracting light that is to be concentrated onto a target positioned along the reflectors/refractors focal line. At the focal line (target) there is typically a container of some sort filled with a working fluid. The advantage of such devices is that the power source being used (the sun) is free.

The main problems with such concentrator assemblies are the concentrator assembly size and the concentrator surface relative to the target. Current concentrators normally need to be at a distance from their target of at least one order of magnitude larger than the size of the target itself and have a surface area several orders of magnitudes larger than that of the target. For any target of size greater than a few centimetres (e.g. a solar panel), a current concentrator will consist of large surface area akin to a sail that will be highly susceptible to the wind and will thus require firm anchoring to the ground through bulky and expensive support. Building a large concentration surface also require a significant expenditure. Though glass mirrors and lenses were originally used as the concentrators, these days silver polymer sheets, flat Fresnel lens or the like can provide the same performance at a much lower cost and weight. The use of several layers of polymers with an internal layer of silver or the like has also been suggested.

There is however, a need to improve flux densities in radiant energy applications by gathering direct and diffused light and redirecting the rays so that they are compressed into dense, directionally focused rays to suit a particular application.

There is also a need for a low cost, very low maintenance tracking or non-tracking concentrator assembly, which is simple to install and works automatically with little to no human intervention.

The full spectrum of daylight during the course of a year can encompass a wide range of positions and intensities. It is therefore desirable to capture light from a customisable area. The present invention seeks to overcome or substantially ameliorate at least some of the deficiencies of the prior art, or to at least provide a viable economic alternative.

It is to be understood that, if any prior art information is referred to herein; such reference does not constitute an admission that the information forms part of the common general knowledge in the art, in Australia or any other country.

### SUMMARY OF THE INVENTION

According to a first aspect, the present invention provides a concentrator assembly comprising:
a plurality of micro ray concentrators, each said micro ray concentrator having an inlet end for collecting rays from a source and concentrating the collected rays toward an outlet end for emitting the rays, wherein the inlet end is larger than the outlet end; and
a plurality of ray redirectors, each said ray redirector having an inlet end to collect said rays from a said micro ray concentrator and redirecting said rays towards an outlet end of the ray redirector for directing said rays at a target.

In a preferred embodiment, the micro ray concentrators are arranged in a contiguous manner, and the inlet ends of the micro ray concentrators are disposed in a cascading arrangement.

In another preferred embodiment, each micro ray concentrator is made from a solid active optical component.

In another preferred embodiment, wherein the ray redirectors are disposed in a cascading arrangement.

In another preferred embodiment, the inlet end of each ray redirector is attached to an outlet end of a respective micro concentrator.

In another preferred embodiment, each ray redirector directs the rays towards a direction of at least 45° to the general direction of the rays emitted from the outlet end of the micro ray concentrator.

In another preferred embodiment, each ray redirector directs the rays towards a direction of about 90° to the general direction of the rays emitted from the outlet end of the micro ray concentrator

In another preferred embodiment, the ray redirectors are made from bent optic fiber pipes.

In another preferred embodiment, the concentrator further includes one or more aggregators to aggregate said rays from said ray redirectors and provide a unified output to said target.

In another preferred embodiment, the aggregator comprises a wave pipe array, each wave pipe having an inlet end to collect rays from the outlet end of one or more of the ray redirectors, and an outlet end attached to the target.

In another preferred embodiment, the aggregator comprises separate wave pipes or slates of a wave transmitting material to funnel the rays to the target.

In another preferred embodiment, the wave pipes or slates partially overlap and/or merge with other wave pipes or slates to form a common or complex aggregator.

In another preferred embodiment, the aggregator comprises a translucent external housing filled with a mixture of water and glycerine.

In another preferred embodiment, the concentrator further includes a target being another concentrator assembly.

In another preferred embodiment, the concentrator further includes a target being one or more solar cells, solar panels, water heating system or other medium to capture energy from concentrated rays.

In another preferred embodiment, the micro ray concentrators are formed integrally with ray redirectors.

In another preferred embodiment, the concentrator further includes an external casing having a transparent or translucent lid housing the micro array concentrators and the ray redirectors, the external casing forming the said aggregator and having the target at one side wall thereof.

In another preferred embodiment, the external casing comprises a least two sides extending at different angles, each side having micro ray concentrators and ray redirectors for redirecting the rays towards a double sided target disposed between the two sides.

In another preferred embodiment, the concentrator array assembly includes means to dissipate unwanted heat from the concentrator assembly.

In another preferred embodiment, said rays are at least one of sunlight, x-rays, radio waves, sound, water waves or microwaves.

Other aspects of the invention are also disclosed.

### BRIEF DESCRIPTION OF THE DRAWINGS

Notwithstanding any other forms which may fall within the scope of the present invention, preferred embodiments of the present invention will now be described, by way of examples only, with reference to the accompanying drawings.

FIG. 1 is an illustration of a schematic view, showing the relation between input and output planes in a concentrator assembly.

FIGS. 2a and 2b are top and side elevation views, respectively, of an array of micro ray concentrators.

FIG. 3 is a side schematic view of the concentrator array of FIG. 2 with a ray redirector array, where a respective ray redirector is attached to each micro ray concentrator.

FIG. 4 is a side elevation view of an aggregator attached to the ray redirector array of in FIG. 3.

FIG. 5 is a side elevation view of another embodiment of an aggregator attached to the ray redirector array depicted in FIG. 3.

FIG. 6 illustrates a schematic view of the path of light waves in a concentrator assembly having eleven ray redirectors and a complex aggregator aiming the light waves onto a single target.

FIG. 7a is a schematic view of a wedge shaped concentrator. FIG. 7b is a schematic view of a new concentrator obtained by splitting a concentrator depicted in FIG. 7a vertically in half.

FIG. 8 is a side cross-section view of two unilateral concentrator assemblies arranged in series.

FIG. 9 is a side cross-section view of two concentrator assemblies arranged in a bilateral manner.

FIG. 10 is a side cross-section view of a wall concentrator assembly.

### DETAILED DESCRIPTION OF THE DRAWINGS

It should be noted in the following description that like or the same reference numerals in different embodiments denote the same or similar features.

1. Concentrator Phase

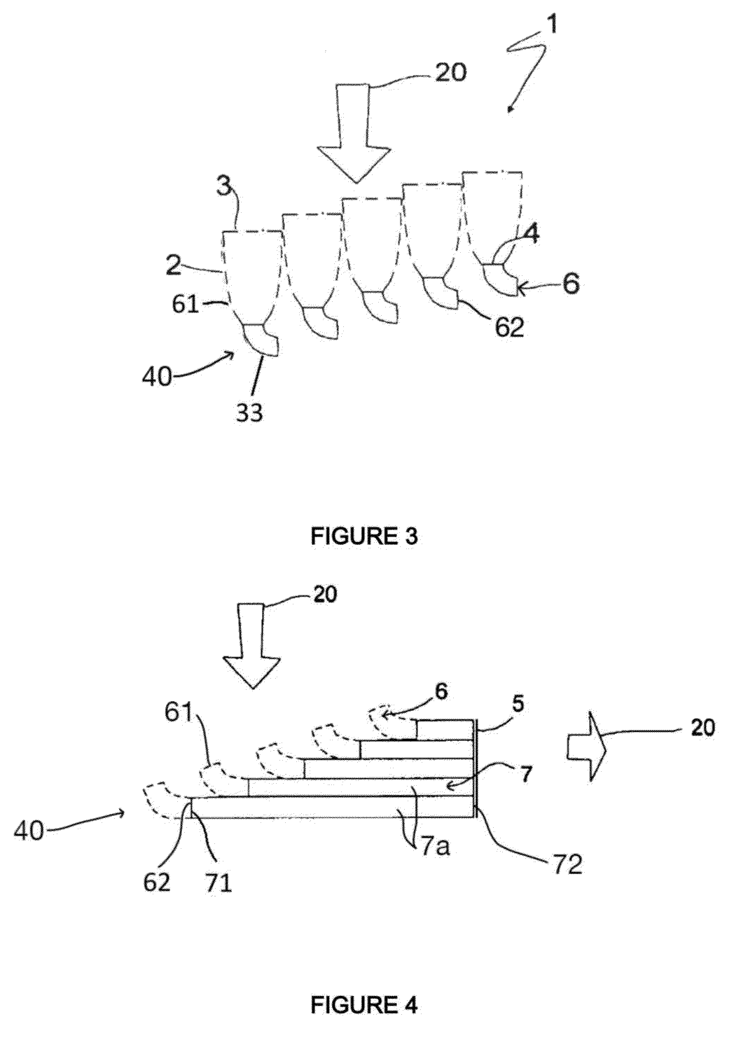

FIGS. 2 to 3 show an array 1 of micro ray concentrators 2. Each micro ray concentrator 2 (also referred to as micro concentrator) comprises a body having a flat upper section 3, and a flat lower section 4 spaced from the upper section 3 and generally parallel thereto. The upper section 3 and lower section 4 are both rectangular in plan profile with the lower section 4 being smaller. The body 30 further comprises side sections 32 which extend from the upper section 3 and converge toward the lower section 4.

Each micro concentrator 2 is solid and made from an active optical component such as glass or a plastics material with a refractive index of around 1.49 (e.g. acrylic). In the embodiment, each micro concentrator is 38 cm wide and 58 cm high. Alternatively, each micro concentrator 2 can be hollow with side sections 32 made from a reflective material such as silver polymer sheets or the like to provide internal reflection.

The upper section 3 of each micro concentrator 2 functions as an inlet 3 for collecting rays 20 within acceptance angle Theta 0 from a source (not shown) and the lower section 4 functions as an outlet 4 to emit rays with an emergence angle Theta i. Each micro concentrator 2 serves a function similar to that of a funnel and concentrates rays 20 entering the inlet 3 towards the outlet 4.

In the array 1, the micro concentrators 2 in plan view are arranged in a contiguous manner, with the rectangular shape of the upper sections 3 assisting this contiguous arrangement. The micro concentrators 2 are also arranged such that the upper sections 3 are set up in a cascading arrangement (at incremental step levels). This arrangement of the micro concentrators 2 in the array 1 assists the concentrator inlets 3 in covering most or all of the input radiation area intended to be concentrated.

The micro concentrators 2 can also comprise active optical components that make use of Total Internal Reflection (TIR).

2. Redirector Phase

FIGS. 3 and 4 show a ray redirector array 40, where each ray redirector 6 is attached to the outlet 4 of each micro concentrator 2. Each ray redirector 6 (also referred to as a redirector) has an inlet end 61 to collect rays 20 within acceptance angle Theta i from the outlet end 4 of a micro concentrator 2, and an outlet end 62 to emit rays with an emergence angle Theta i. Each ray redirector 6 is curved and redirects said rays 20 towards a desired direction. In the embodiment, each redirector 6 redirects the rays 20 substantially towards a 90° angle, being substantially perpendicular to the general direction of the rays emitted from the outlet 4 of the micro concentrator 2.

The inlet end 61 of each redirector 6 matches the outlet 4 of one or more concentrators 2. The redirectors 6 are made from some form of reflector/refractor such as bent pipes (e.g. optic fibre with small bends), or are specialised angle rotator.

The cascaded arrangement of the concentrators 2 provides a corresponding cascaded arrangement of the outlets 4. In a similar way to the micro concentrators 2, the redirectors 6 are placed at different levels. This allows for similar length redirectors 6 to direct their outlet ends 62 in parallel directions.

Each redirector 6 is solid and made from an active optical component such as glass or a plastics material with a refractive index of around 1.49 (e.g. acrylic). Alternatively, each redirector 6 is hollow with side sections 33 made from a reflective material such as silver polymer sheets or the like to provide internal reflection.

A redirector 6 may comprise active optical components that make use of TIR.

In the specification, the terms “ray redirector” or “redirector” includes reference to a static component that redirects light—that is, a component that redirects the light plane without changing the concentration (i.e. all rays are redirected).

3. Aggregator Phase

FIG. 4 shows an aggregator 7 (also referred to as wave pipe array 7). Each wave pipe 7 has an inlet end 71 to collect rays 20 from the outlet end 62 of one or more of the ray redirectors 6, and an outlet end 72 that is attached to a target 5. An aggregator 7 aggregates the rays 20 to a part or the entirety of the target 5. It can be seen that the target 5 is disposed in an orientation substantially parallel to the general input direction of the rays 20.

The aggregator 7 comprises separate wave pipes or slates 7a of any wave transmitting material to funnel the rays 20 to the common target 5. From the inlet ends 71 to the outlet ends 72 of the aggregator 7, the wave pipes or slates 7a may partially overlap and merge with other wave pipes or slates to become a common or complex aggregator.

The inlet ends 71 of each aggregator 7 will exactly match the outlet ends 62 of one or more of the redirectors 6. As shown in FIG. 4, the inlet ends 71 are staggered in a step manner to match the positions of the outlet ends 62 of the redirectors 6.

The aggregators 7 may comprise of plastic fibres/fibre optics/tubes/systems that make use of TIR. Additionally, or alternatively, water coupled with additives contained within a tube made of glass/plastic can be used to achieve the same effect and additionally provide a source of heat dissipation/cooling.

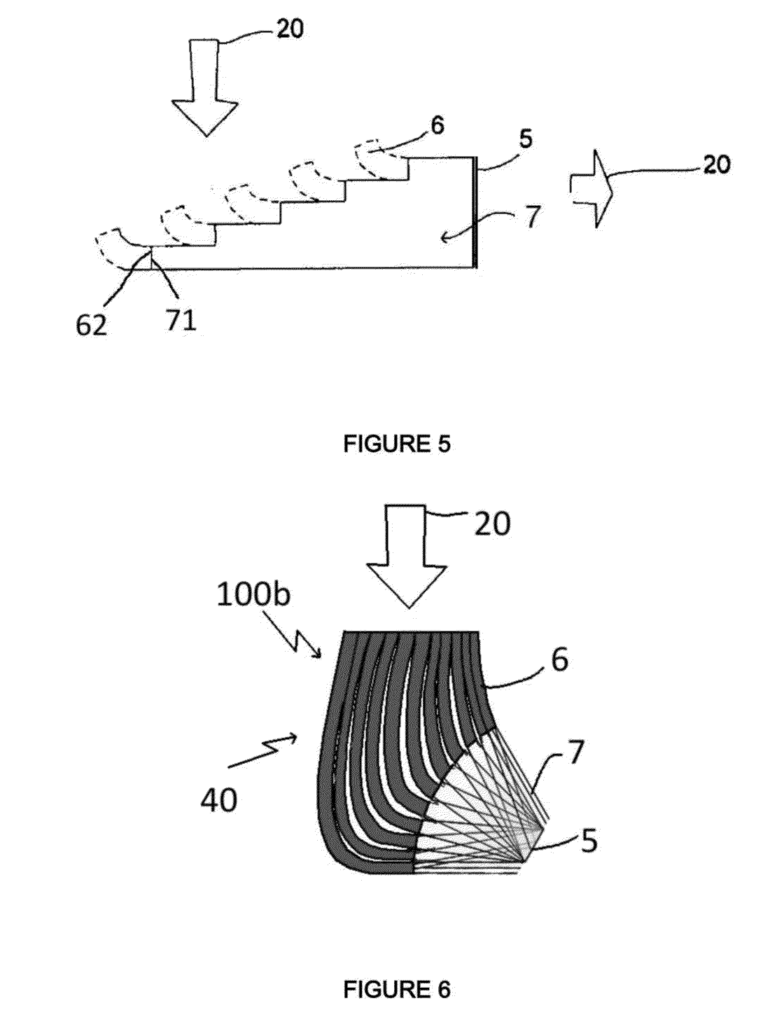

FIG. 5 shows an alternative embodiment of an aggregator 7 which is the equivalent of a combination of several/all of the wave pipes 7a in a single complex aggregator with equivalent optical properties. This complex aggregator can be made at a very low cost by using glass/plastic for the external housing shape and a filling of suitable low cost materials (e.g. water with additives such as glycerine to increase its refraction index and reduce its freezing point, white mineral oil, etc.). Alternatively, the housing can simply be hollow and filled with air.

In the above embodiments, it is also possible to form the micro concentrators 2 integrally with redirectors 6, in which case the outlet of the micro concentrators 2 (being the outlet of the redirectors 6) will attach to the inlet of the aggregator 7. It is also possible to omit the redirectors 6, in which case the outlet of the micro concentrators 2 will attach to the inlet of the aggregator 7. The target 5 in the embodiment can be a solar panel.

### Example Use of a Preferred Embodiment

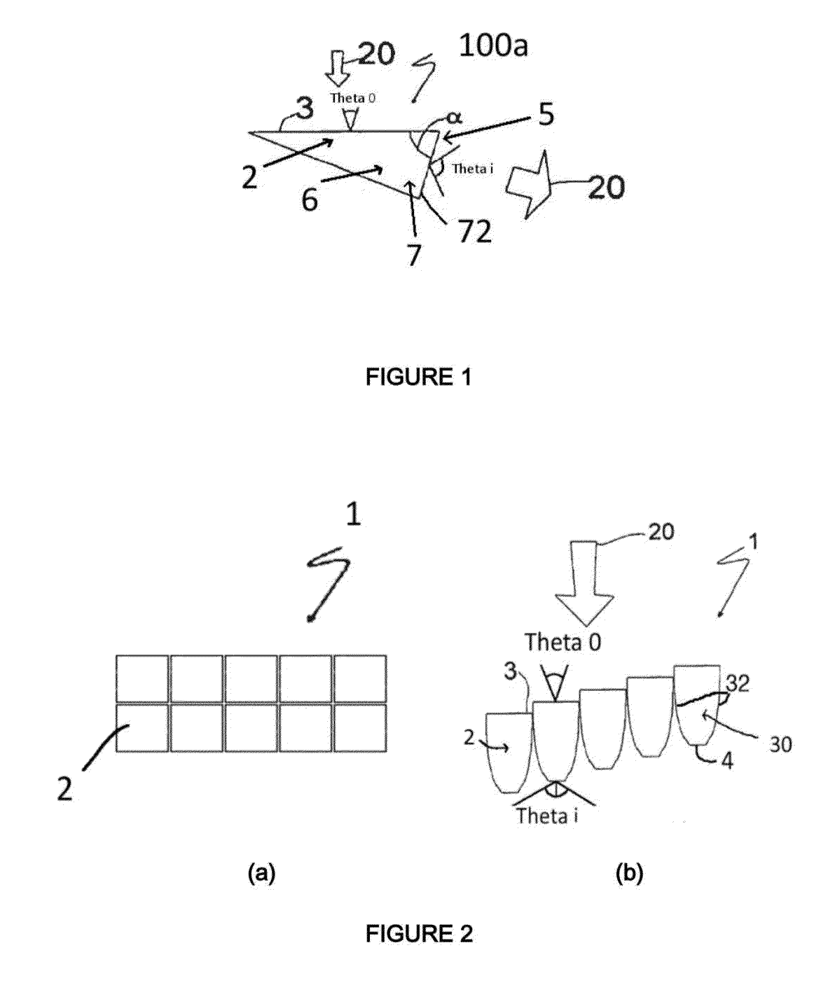

FIG. 1 illustrates the travel direction of light rays 20 through a two dimensional concentrator assembly 100a, having inlet ends 3 (with angle of acceptance Theta 0), an outlet end 72 (with angle of emergence Theta i) and a refraction angle ?. To achieve a unified concentrated output into target 5, a combination of micro concentrators 2, redirectors 6 and aggregator 7 in three phases is used to form the concentrator assembly.

The concentrator phase is utilized to collect and concentrate a portion of the input rays 20 (with angle of acceptance Theta 0) and generate an output (with angle of emergence Theta i).

The redirector phase (in cases where the concentrator phase does not provide a redirection angle ? or larger) is utilised to take the output 4 of each of the micro concentrators 2 as input and generate an output with the redirection desired (with angle of emergence Theta i).

The aggregation phase is utilized to take the output of the redirector phase as input (with angle of emergence Theta i) and generate a unified output that would cover most, or all, of the target 5.

The target 5 as described above can be a solar panel, solar cell or anything that benefits from increased concentration of waves. The preferred embodiment of the concentrator assembly thus concentrates and directs rays 20 from a large input area onto a smaller target 5. The flux density of rays 20 toward the target 5 is dramatically increased.

Features, Advantages and Alternatives

The micro concentrators 2 and redirectors 6 have zero or minimal optical loses. The output of each phase closely/exactly matches the input of the next phase. The emergence angle of each phase matches the acceptance angle of the next. The level of concentration of the concentrator array 1 will be the average of the level of concentration of the component micro concentrators 2.

For practical purposes all components will be engineered to minimise loses by reflection and refraction.

The volume/size of the combination of a micro concentrator 2 and a redirector 6 is linearly dependent on their number. Therefore, phase 1 and 2 of the concentrator assembly 100a can be downsized to small volumes/sizes which may then be combined sequentially (taking up minimal space). Phase 3 (aggregator) cannot be reduced in a similar way by increasing the number of components but their size/volume is still far less than that in alternative concentrator solutions.

The complexity of building Phase 1 and 2 is low in the case of a one dimensional concentrator assembly 100a because the combination of both phases can be made in a planar surface. Techniques such as acrylic cutting can be applied to minimise the manufacturing cost. Phase 3 can include simple geometrical figures that can be built using standard plastic manufacturing processes.

Phase 1 and 2 components can be reduced in cost/weight by increasing the number of components. Phase 3 (aggregation phase) can be reduced in cost by using the complex aggregator embodiment using a suitable low cost filling material. Still another option is to use air as the complex aggregator filling material. This solution will be very convenient in cost/weight but will incur a certain loss in its concentration due to reflection loses in the interface between redirectors and aggregator.

A reflective coating on the concentration phase can be used to reflect any infrared. Also the aggregator 7 can provide heat dissipation. For example, most of the heat can be captured and dissipated by using a complex aggregator 7 using a suitable filling material to capture the heat and channel it to external radiators (not shown) situated in a way that does not interfere with the incoming radiation. An example of this may include water (coupled with other compounds) transmitting electromagnetic waves whilst dissipating heat from the cells.

The above embodiments can be applied to concentrate the full area of the input or only one dimension at a time. It is possible to take the output 72 of the first concentrator assembly 100a and use it as input for a second stage concentrator assembly 100a (typically far smaller than the first one). This arrangement is particularly useful when the first concentration was only applied in one dimension. In this particular case, the second concentrator assembly 100a could apply the concentration in the dimension orthogonal to that which was applied in the first stage. Multiple stages could be used to overcome limitations in the emergence angle brought about by the use of TIR in each of the subcomponents.

FIG. 6 shows a lateral cross-section view of a concentrator assembly 100b with a possible variation which is to overlap the output of redirectors 6 and a complex aggregator 7 (phase 2 and 3 above) such as their emergence angle is mostly included inside a common target 5. This combined output over the target 5 becomes equivalent to having one concentrator with a broader emergence angle and the sum of flux densities of each redirector 6, therefore achieving higher flux density. When using a small acceptance angle, redirectors could be easily approximated by very common and low cost geometric forms such as bent tubes and sheets. These concentrators can also be of use by themselves for specific applications due to their very low cost components. For example, one can use 11 redirectors to produce a concentration of more than eight times. This variation of the concentrator would also be quite close to an ideal concentrator if the redirectors are ideal (i.e. there are no losses/changes in the emergence angle in the redirectors phase), each emergence angle exactly matches the common target and the number of components is high enough. In practical terms, ten or more redirectors would provide a sensible approximation to an ideal concentrator.

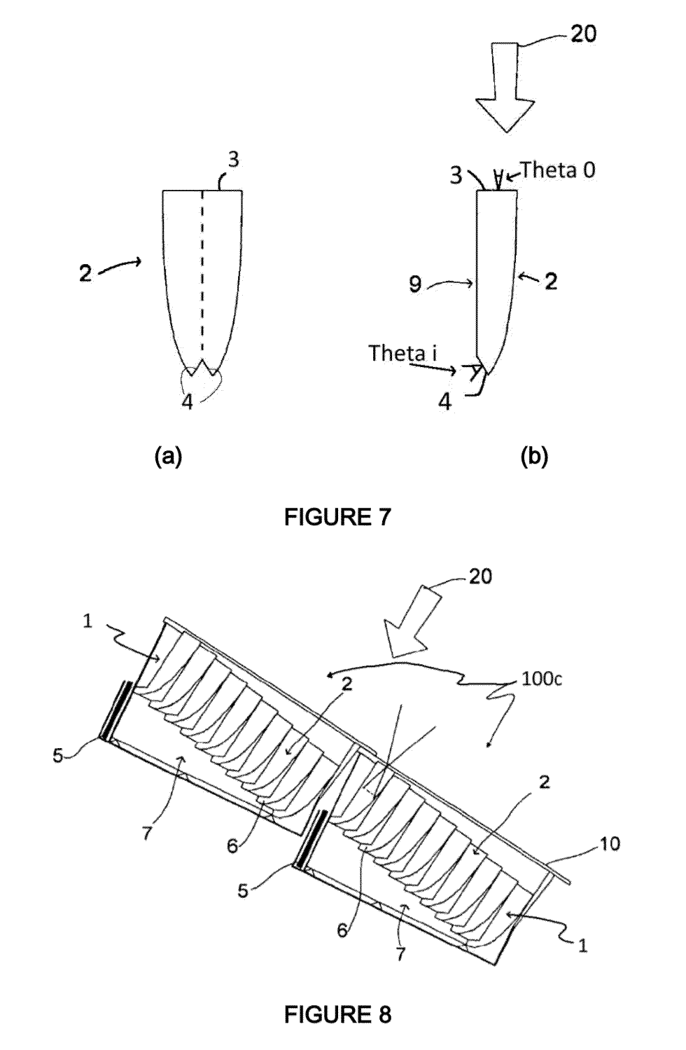

Micro concentrators could contain in themselves a redirector component. Examples of this type of micro concentrator 2 include the halved wedged concentrator shown in FIG. 7b; having a Theta 0/Theta i variation of this design (with emergence angle Theta i instead of 180 degrees). The halved wedged Theta 0/Theta i concentrator 9 is obtained by splitting concentrator 2 in FIG. 7aat its optical axis/symmetrical axis XX. The adaptation of the Theta 0/Theta i concept is done to ensure that TIR is achieved. It could also be truncated to reduce its size.

FIG. 8 shows a lateral cross-section view of two unilateral concentrator assemblies 100c placed in series, each one with 10 micro concentrators 2 (with acceptance/emergence angles 19°/55°) and redirectors directing rays 20 to a solar cell 5. The micro concentrator 2 and attached redirectors 6 are enclosed in an encasing box 10 which also forms the aggregator 7. The encasing box 10 comprises a transparent lid and can be made from a stronger material such as polycarbonate. This particular example has an acceptance angle of almost 19° and provides a maximum concentration of 3.6× (which is 3.2× the energy generated by the standalone solar cell in average), making it suitable for static applications in the residential sector. It can use standards solar cells 5 and the aggregator 7 can be filled with water, mineral oil or the like to minimize production costs.

A variation of this design using a large number of components (e.g. 50+ micro concentrators) and smaller solar cells (5 cm width) would be suitable for residential applications as a solar tile or a replacement of standard solar panels or the like.

This should reduce the cost of energy per watt by concentrating light on the left extreme. By increasing the number of micro concentrators/redirectors, the concentrator/redirector phases can be resized and shrunk to minute proportions creating a virtually flat surface. The design may be replicated successively to achieve concentration in multiple dimensions. Any material that allows for the transmission of waves in turn may perform the concentration. Examples include, but are not limited to, glass, plastics, water and combinations of materials. The transmission (funnelling) may be carried out through means other than plastic, solids or liquids (even air). It is also translucent to the early morning and late afternoon light.

This could be replicated with different acceptance and emergence angles, number of components; the use of a series of wave pipes 7a instead of a single complex aggregator; the use of other types of micro concentrators 2 and redirectors 6 with different acceptance/emergence angles Theta 0/Theta i and using other solar energy capture mediums (e.g. water for solar water heating).

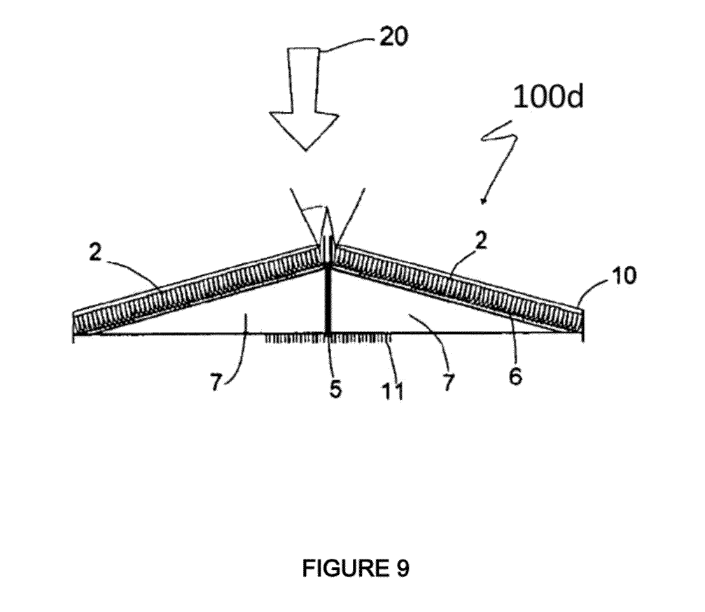

Referring to FIG. 9, there are shown two concentrator assemblies arranged in a bilateral manner that concentrates waves that approach from remote sources (e.g. the sun). It combines 104 halved wedged Theta 0 Theta i truncated micro concentrators 2 corresponding to the concentrator phase, with the same number of redirectors 6 and two complex aggregators 7 that funnel the light to either side of a bifacial solar cell/panel 5.

FIG. 9 shows a lateral cross-section view of two concentrator assemblies 100d arranged in a bilateral manner with 104 micro concentrators 2 (with acceptance/emergence angles 19°/55°) and redirectors 6. Active optical components can be made from glass or plastic with a refractive index around 1.49 (e.g. acrylic) and directed to a bifacial (double-sided) solar cell/panel 5. An encasing box 10 and two complex aggregator components 7 can be used (said encasing box 10 and aggregators 7 made from a transparent but stronger material such as polycarbonate). A passive cooling component 11 with fins designed to capture and dissipate the heat from the solar cell 5 and the aggregator filling medium (that it is also playing a cooling role) could be utilised. The top cooling component also plays the role of removable lid of the concentrator assembly 100d enabling the easy maintenance/replacement of the solar cells/panel 5 when required. The complex aggregator 7 could be filled with filling materials (e.g. mineral oil) to minimize cost.

This particular example has an acceptance angle of almost 30° and provides a maximum concentration of 6.7× (which is 5.9× the energy generated by one side of a standalone bifacial solar cell in average), making it suitable for static applications in the industrial sector. The input planes of each side of the concentrator assembly 100d have been oriented to slightly different angles to smooth the concentration peak and reduce losses through overheating of the solar cell/panel 5. The top two sides of the concentrator assembly 100d cover play a similar role by bending the light in different directions, increasing the acceptance angle of the concentrator assembly 100d.

The high level of average concentration can reduce the cost of the solar cells/panel required to about 20 per cent; making this concentrator assembly 100d ideal for high scale production of solar energy (e.g. solar farms).

Applying the generic idea behind the model above, concentration may be applied onto a central pivot or target. This pivot/target may be solar panels, or tubes (to heat liquids/gases) or anything else that may benefit from concentration on multiples sides.

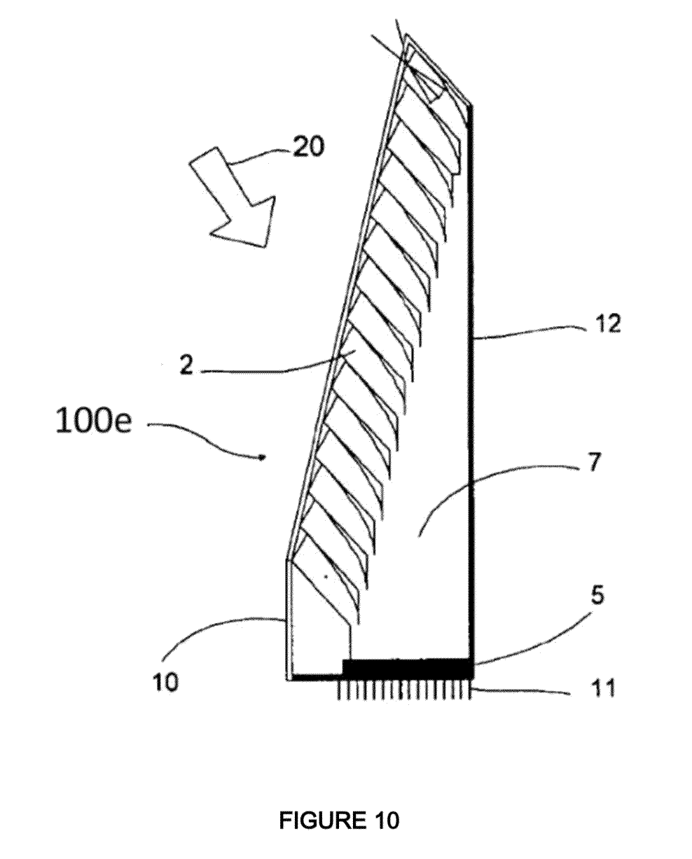

Referring to FIG. 10, there is shown a concentrator assembly 100e that combines a series of half wedged Theta0/Theta i truncated concentrators 2 (as shown in FIG. 7b) corresponding to the concentrator phase and a complex aggregator 7 that funnels the light to the solar cell/panel 5. This embodiment does not require redirectors because the selected concentrators 2 provide the redirection required. This embodiment is designed to be used on the wall 12 of a building.

The wall concentrator assembly 100e of FIG. 10 shows 15 micro concentrators 2 (with acceptance/emergence angles 19°/55°). Active optical components are made from glass or plastic with a refractive index of around 1.49 (e.g. acrylic).There is a solar cell/panel 5, an encasing box 10 and a complex aggregator component (both encasing box 10 and complex aggregator 7 that can be made from a transparent but stronger material such as polycarbonate). A passive cooling component with fins 11 designed to capture the heat from the solar cell 5 and the aggregator filling medium (that it is also playing a cooling role) is provided.

This particular example has an acceptance angle of almost 19° and provides a maximum concentration of 3.6× (which is 3.2× the energy generated by the standalone solar cell in average), making it suitable for static applications in building and factories. It could use standard solar cells and the aggregator 7 could be filled with filling materials such as water with additives or mineral oil to minimize cost. The angle of acceptance is 19° though it is in practice slightly higher because of the use of truncated micro concentrators 2.

This example displays the application of the general design on vertical surfaces 12. Since the angle of acceptance may be manipulated by design quite readily, these can be geared to function very efficiently at certain times of the day, and may be placed on vertical walls 12 or angled surfaces at any height. The use of a cover serves for wind protection and allows integration into structures so that designs may be aesthetically pleasing.

In the embodiment, the target solar panel 5 is 96 cm wide and 5 cm high. Each micro concentrator 2 is 35 cm wide and 58 cm high. The concentrator assembly 100e is 421 cm high and 120 cm wide.

The concentrator assembly 100e will have a dimension of 1650 cm in the z axis (not shown in this lateral view). Each one of the concentrator assembly components (including the solar panel) will have a similar dimension along this axis.

The concentrator assembly 100e input area will be 6.7 square meters while each micro concentrator input area will be 0.44 square meters.

This embodiment is intended to reduce the cost of energy per watt by concentrating light on the bottom extreme. By increasing the number of micro concentrators/redirectors, the concentrator/redirector phase components can be resized and shrunk to minute proportions creating a virtually flat surface. The design may be replicated successively to achieve concentration in multiple dimensions. Any material that allows for the transmission of waves in turn may perform the concentration. Examples include, but are not limited to, glass, plastics, water and combinations of materials. The transmission (funnelling) may be carried out through means such as plastics, solids, liquids or gases (e.g. air).

The aggregator model outlines a generic design that could be replicated with different acceptance and emergence angles, number of components, use of a series of wave pipes instead of a single complex aggregator and/or and using other solar energy capture mediums (e.g. water for solar water heating).

Applications

In essence, the present invention improves flux densities in radiant energy applications by gathering direct and diffused light and redirecting the rays so they may be compressed into dense, directionally focused rays to suit a particular application.

The design may be used as a very low maintenance non-tracking concentrator, which is simply installed and left to be. It may also be designed with a simple and cheap (and thus relatively inaccurate) tracking element. Due to its nature, this design would give such tracking a high tolerance for error.

Concentration Photovoltaic

The system could be used for both tracking and static concentration PV. As a tracking system, it dispenses with the need for elaborate tracking methods as it has a wide scope for error as opposed to conventional tracking concentration techniques. This can allow for cheap concentration mechanisms, that aim being to make the most of concentration to reduce costs, but seek to avoid incorporating costly supplements such as tracking.

The full spectrum of daylight during the year can encompass a wide area. This design can be adapted to capture light from a customisable (to specific regions of the world) area, however, due to the trade-off between concentration and the reception area, the solar design should tend to capture light form higher intensity positions to maximise returns.

This concept may also be extended to the idea of solar tiles, whereby a concentrator is designed to mirror a roof tile, thus allowing households to readily incorporate concentration into their residencies without an unappealing loss in aesthetics.

Solar Heating

The present invention may be readily applied to systems of water heating. Its efficiency would far surpass the current systems of water heating whilst retaining low costs. The reason for this being that current water heating systems do not concentrate to any degree, they utilize heat retention systems to capture incoming heat. It is naturally inefficient since each square inch can only capture that heat which traditionally falls within it. With concentration, these systems can achieve much higher levels of efficiency and provide much improved functionality in colder environments.

Radio and Micro-Wave Concentrator

The invention has the capacity to act as a radio and TV wave parabola, but with a much greater margin of error making it easier to focus.

The invention also has uses as a TV antenna due to its potential for a wide acceptance angle. It would also be able to replace traditionally unappealing antenna designs. Being a flat and having a relatively thin surface it has the potential to be in a highly competitive position over the alternatives. It would also generate a higher quality signal than current antennas.

The concept can be extended to any wave.

As a collimator—The present invention may be inverted so as to generate a collimator. This could have a myriad of applications, such as, but not limited to, lasers.

Whilst preferred embodiments of the present invention have been described, it will be apparent to skilled persons that modifications can be made to the embodiments described.

The present invention provides a compact concentrator assembly as the concentrators able to concentrate rays from a predetermined area, the redirectors being able to redirect the rays towards a target disposed at an orientation substantially parallel to the input direction of the rays. In other words, in a generally rectangular cross-section housing, the concentrators are able to be disposed along an extended upper surface of the housing and the target can be disposed at a short side wall of the housing.

1. A concentrator assembly comprising:
a plurality of micro ray concentrators, each micro ray concentrator having an inlet end for collecting rays from a source and an outlet end for emitting the rays, said inlet end concentrating the collected rays toward said outlet end, wherein the inlet end is larger than the outlet end; and
a plurality of ray redirectors, each said ray redirector having an inlet end to collect rays from a respective micro ray concentrator and an outlet end to direct the rays at a target, said inlet end redirecting the rays towards said outlet end of the ray redirector.

2. The concentrator assembly according to claim 1, wherein the micro ray concentrators are arranged in a contiguous manner, and wherein inlet ends of the micro ray concentrators are disposed in a cascading arrangement.

3. The concentrator assembly according to claim 1, wherein each micro ray concentrator is comprised of a solid active optical component.

4. The concentrator assembly according to claim 1, wherein the ray redirectors are disposed in a cascading arrangement.

5. The concentrator assembly according to claim 1, wherein the inlet end of each ray redirector is attached to an outlet end of a respective micro concentrator.

6. The concentrator assembly according to claim 1, wherein each ray redirector directs the rays towards a direction of at least 45° to the a general direction of the rays emitted from the outlet end of the micro ray concentrator.

7. The concentrator assembly according to claim 1, wherein each ray redirector directs the rays towards a direction of about 90° to the a general direction of the rays emitted from the outlet end of the micro ray concentrator

8. The concentrator assembly according to claim 1, wherein the ray redirectors are comprised of bent optic fiber pipes.

9. The concentrator assembly according to claim 1, further comprising: an aggregator of rays from said ray redirectors, said aggregator providing a unified output to said target.

10. The concentrator assembly according to claim 9, wherein the aggregator comprises a wave pipe array, each wave pipe having an inlet end to collect rays from the outlet end of one or more of the ray redirectors, and an outlet end attached to the target.

11. The concentrator assembly according to claim 10, wherein the aggregator comprises at least one element of a group consisting of separate wave pipes and separate slates, being comprised of a wave transmitting material to funnel the rays to the target.

12. The concentrator assembly according to claim 11, wherein the at least one element partially overlap an other at least one element to form a common or complex aggregator.

13. The concentrator assembly according to claim 10, wherein the aggregator comprises a translucent external housing filled with a mixture of water and glycerine.

14. The concentrator assembly according to claim 1, further comprising a target being comprised of another concentrator assembly.

15. The concentrator assembly according to claim 1, further comprising: a target being selected from at least one of a group consisting of solar cells, solar panels, water heating system, and another medium to capture energy from concentrated rays.

16. The concentrator assembly according to claim 1, wherein the micro ray concentrators are formed integrally with ray redirectors.

17. The concentrator assembly according to claim 9, further comprising: an external casing having a lid housing the micro array concentrators and the ray redirectors, the external casing forming the said aggregator and having the target at one side wall thereof.

18. The concentrator assembly according to claim 17, wherein the external casing comprises a least two sides extending at different angles, each side having micro ray concentrators and ray redirectors for redirecting the rays towards a double sided target disposed between the two sides.

19. The concentrator assembly according to claim 1, wherein the concentrator array assembly includes means to dissipate unwanted heat from the concentrator assembly.

20. The concentrator assembly according to claim 1, wherein said rays are comprised of at least one of a group consisting of sunlight, x-rays, radio waves, sound, water waves and microwaves.
